(19) United States
(12) Patent Application Publication
(10) Pub. No.: US 2024/0375371 A1
(43) Pub. Date: Nov. 14, 2024

(54) ENVELOPES WITH CLOSURE SEALS FORMED FROM REACTIVATABLE HOT-MELT ADHESIVE

(71) Applicant: Pregis Innovative Packaging LLC, Bannockburn, IL (US)

(72) Inventor: Thomas D. Wetsch, Naples, FL (US)

(21) Appl. No.: 18/660,061

(22) Filed: May 9, 2024

Related U.S. Application Data
(60) Provisional application No. 63/501,116, filed on May 9, 2023.

(51) Int. Cl. B31B 70/62; B65D 27/18

(52) U.S. Cl. CPC B31B 70/62; B65B 5/045; B65B 51/146; B65D 27/18; B65B 43/267

(57) ABSTRACT

Envelopes include a closure seal formed from a hot-melt adhesive. The hot-melt adhesive is reactivated after an item to be packaged is inserted into a pocket of the envelope by way of an opening defined by walls of the envelope. The reactivation of the hot-melt adhesive results in the formation of the closure seal, which affixes portions of the walls to each other so as to close the opening, causing the item to be retained within the envelope.

### CROSS-REFERENCE TO RELATED APPLICATIONS

The present application claims priority of U.S. Patent Application No. 63/501,116, filed May 9, 2023, which is incorporated herein by reference in its entirety.

### FIELD

The present disclosure relates generally to packaging for holding items, for example, during shipping. More specifically, the present disclosure relates to packaging materials, such as envelopes, that include a closure seal formed from a reactivatable hot-melt adhesive.

### BACKGROUND

The use of shipping envelopes formed from paper has been growing in popularity in relation to poly bags, i.e., bags made of plastics such as polyethylene and polystyrene, due to the recyclability of paper. Poly bags typically are sealed closed after being loaded by a heat seal formed by heating portions of opposing walls of the bag so that the wall portions fuse together. Sealing a paper envelope, by contrast, typically requires a separate bonding element in the form of an adhesive material deposited on one or both of the opposing walls. The use of a separate bonding element can present challenges not present when heat sealing poly bags. For example, the tackiness of the adhesive material can make it difficult to separate the walls of the envelope so that the envelope can be loaded, particularly when using automated equipment to open and seal the envelope. Also, the low ignition temperature of paper, in comparison to polyethylene and polystyrene, can make if difficult to form an adequate closure seal when using a heat-activatable material as the bonding element.

### SUMMARY

In one aspect, the disclosed technology relates to an envelope for holding an item. The envelope includes a first flexible wall, and a second flexible wall overlying the first flexible wall and affixed to the first flexible wall about at least a portion of a pocket border. The pocket border encloses a pocket defined between the first and second flexile walls and configured and dimensioned to contain the item. At least one of the first and second flexible walls defines a pocket opening allowing access to the pocket from an exterior of the envelope for loading the item into the pocket.

The envelope also includes a closure-sealing element disposed on the body of the envelope and positioned to seal closed the pocket opening. The closure-sealing element is made of a hot-melt adhesive that has a sufficiently low tackiness at room temperature to enable the closure-sealing element to be separated from the second flexible wall by hand, and is activatable when heated to a temperature above an activation temperature and, when subsequently cooled to a temperature below the activation temperature, adheres to the second flexible wall to seal the pocket opening closed to retain the item in the pocket.

In another aspect of the disclosed technology, a supply web includes a plurality of the above envelopes connected in series.

In another aspect of the disclosed technology, the hot-melt adhesive has a sufficiently low tackiness at room temperature to enable the closure-sealing element to be peeled from second flexible wall.

In another aspect of the disclosed technology, the hot-melt adhesive has a sufficiently low tackiness at room temperature to enable the closure-sealing element to be separated from the second flexible wall without damaging the first or the second flexible wall.

In another aspect of the disclosed technology, the first and second flexible walls are affixed to each other about a first portion of the pocket border, and are unaffixed to each other at the pocket opening.

In another aspect of the disclosed technology, the first and second flexible walls are unaffixed at an open side of the pocket; and the pocket opening is defined by the open side of the pocket.

In another aspect of the disclosed technology, the pocket opening is disposed along the pocket border.

In another aspect of the disclosed technology, the pocket opening is defined between the first and second flexible walls.

In another aspect of the disclosed technology, the closure-sealing element is configured to seal closed the pocket opening by affixing the second flexible wall to the first flexible wall.

In another aspect of the disclosed technology, the closure-sealing element is disposed at the pocket opening.

In another aspect of the disclosed technology, the hot-melt adhesive is offset from an upper edge of the first wall by a sufficient distance to permit the user to manually grasp and pull apart the first and second walls after the closure seal has been formed.

In another aspect of the disclosed technology, the hot-melt adhesive is offset from the upper edge of the first wall by about 0.25 inch.

In another aspect of the disclosed technology, the hot-melt adhesive is configured to be reactivated by the application of heat through at least one of the first and second flexible walls of the envelope, the application of heat being sufficient to heat the hot-melt adhesive to the temperature above the activation temperature.

In another aspect of the disclosed technology, the closure-sealing element is disposed on the body in an elongated band.

In another aspect of the disclosed technology, the hot-melt adhesive has a sufficiently low tackiness at temperatures of about 110° F. and below to enable the closure-sealing element to be separated from the second flexible wall by hand.

In another aspect of the disclosed technology, the body further includes a flap connected to the first flexible wall, the closure-sealing element is disposed on the flap, and the closure-sealing element is configured to seal closed the pocket opening by affixing the second flexible wall to the flap.

In another aspect of the disclosed technology, the hot-melt adhesive has an activation temperature below about 140° F.

In another aspect of the disclosed technology, the closure-sealing element and the pocket border define a gap configured to provide venting between the pocket and the ambient environment.

In another aspect of the disclosed technology, the at least one of the first and second flexible walls is a padded wall.

In another aspect of the disclosed technology, a method of making an envelope for holding an item includes providing a body of the envelope having a first and a second flexible wall, and affixing the second flexible wall to the first flexible wall about at least a portion of a pocket border. The pocket border encloses a pocket defined between the first and second flexile walls and is configured and dimensioned to contain the item. At least one of the first and second flexible walls defines a pocket opening allowing access to the pocket from an exterior of the envelope for loading the item into the pocket.

The method also includes positioning a closure-sealing element on the body to seal closed the pocket opening. The closure-sealing element is made of a hot-melt adhesive that has a sufficiently low tackiness at room temperature to enable the closure-sealing element to be separated from the second flexible wall by hand, and is activatable when heated to a temperature above an activation temperature and, when subsequently cooled to a temperature below the activation temperature, adheres to the second flexible wall to seal the pocket opening closed to retain the item in the pocket.

In another aspect of the disclosed technology, positioning a closure-sealing element on the body to seal closed the pocket opening includes placing the closure-sealing element on the first wall.

In another aspect of the disclosed technology, positioning a closure-sealing element on the body to seal closed the pocket opening includes placing the closure-sealing element on a flap of the body.

In another aspect of the disclosed technology, a method for packaging an item includes providing an envelope having a body including a first flexible wall, and a second flexible wall overlying the first flexible wall and affixed to the first flexible wall about a containment border that encloses a plurality of sides of a pocket defined by the first and second flexible walls. The envelope also includes a closure-sealing element disposed on the body and positioned to seal closed the pocket opening. The closure-sealing element is made of a hot-melt adhesive that has a sufficiently low tackiness at room temperature to enable the closure-sealing element to be separated from the second flexible wall by hand, and is activatable when heated to a temperature above an activation temperature and, when subsequently cooled to a temperature below the activation temperature, adheres to the second flexible wall to seal the pocket opening closed to retain the item in the pocket.

The method further includes placing the item in the pocket, and heating the closure-sealing element to the temperature above the activation temperature.

In another aspect of the disclosed technology, heating the closure-sealing element to the temperature above the activation temperature includes applying heat to the hot-melt adhesive through at least one of the first and second flexible walls.

In another aspect of the disclosed technology, the method further includes applying pressure to the closure-sealing element while heating the hot-melt adhesive to the temperature above the activation temperature.

In another aspect of the disclosed technology, a bagging system includes an envelope, and a bagging machine configured to receive the envelope. The bagging machine includes a press configured to urge the first flexible wall and the closure-sealing element toward the second flexible wall, and a heat sealer configured to apply heat to the closure-sealing element sufficient to heat the closure-sealing element to the temperature above the activation temperature.

In another aspect of the disclosed technology, the heat sealer is further configured to apply the heat to the closure-sealing element through the first wall.

In another aspect of the disclosed technology, the bagging system further includes an opening device configured to open the pocket opening so that the item can be inserted into the pocket.

In another aspect of the disclosed technology, the bagging system further includes a supply web that includes a plurality of the envelopes connected in series.

In another aspect of the disclosed technology, a bagging machine is configured to package an item in a packaging container formed from a web stock, the web stock having at least one layer of a paper or plastic material, and a closure-sealing element located on a first portion of an outer surface of the at least one layer, the closure-sealing element being made of a hot-melt adhesive. The bagging machine includes a guide configured to cause the web stock to fold along a longitudinally extending fold line and assume a folded configuration so that the closure-sealing element faces a second portion of the outer surface of the at least one layer.

The hot-melt adhesive has a sufficiently low tackiness at room temperature to enable the closure-sealing element to be separated from the second portion of the outer surface of the at least one layer by hand. The hot-melt adhesive is activatable when heated to a temperature above an activation temperature and, when subsequently cooled to a temperature below the activation temperature, adheres the second portion of the outer surface of the at least one layer to the first portion of the outer surface of the at least one layer.

The bagging machine further includes a cutting and sealing unit configured to press the closure-sealing element into the second portion of the outer surface of the at least one layer while heating the closure-sealing element to the temperature above the activation temperature.

In another aspect of the disclosed technology, the bagging machine further includes a pulling device configured to grasp a lower end of the web stock and pull the web stock to advance the web stock through the bagging machine.

In another aspect of the disclosed technology, the pulling device includes two opposing arms configured to reciprocate between an inward position and an outward position to grasp and release the web stock, and to translate between an upper position and a lower position to advance the web stock through the bagging machine.

In another aspect of the disclosed technology, the bagging machine further includes fingers configured to spread side edges of web stock apart after the web stock has been folded, so that the item can be placed within the C-folded web stock.

In another aspect of the disclosed technology, the cutting and sealing unit includes two opposing arms that reciprocate between an inward position and an outward position; and two L-shaped sealer-cutters each mounted on a respective one of the arms.

In another aspect of the disclosed technology, the sealer-cutters are L-shaped, and are configured to form a longitudinally-extending seal and a transversely-extending seal from the closure-sealing element.

In another aspect of the disclosed technology, the cutting and sealing unit includes a rolling longitudinal sealer and a horizontal bar.

In another aspect of the disclosed technology, the cutting and sealing unit includes a horizontal sealer configured to roll or slide across the web stock.

In another aspect of the disclosed technology, the cutting and sealing unit is further configured to sever the packaging container from the web stock.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of an envelope with a closure-sealing element formed from a hot-melt adhesive;

FIG. 2 is a perspective view of the envelope shown in FIG. 1, in a sealed condition with a closure seal formed from the closure-sealing element;

FIG. 3 is a front view of the envelope shown in FIG. 1, with a front wall of the envelope removed for purposes of illustration;

FIG. 4 is a magnified view of the area designated “IV” in FIG. 3;

FIG. 5 depicts the formation of a continuous web stock of the envelopes shown in FIG. 1;

FIG. 6 is a perspective view of a bagging machine configured for use with the envelope shown in FIG. 1;

FIG. 7 top-side perspective view of another embodiment of an envelope;

FIG. 8 is a longitudinal cross-sectional view of a portion of a web stock of the envelopes shown in FIG. 7;

FIG. 9 is a transverse cross-sectional view of another embodiment of an envelope;

FIG. 10 is a perspective view of a web stock of another embodiment of an envelope;

FIG. 11 is a cross-sectional view taken through the plane “XI-XI” of FIG. 10;

FIG. 12 is a cross-sectional view taken through the plane “XII-XII” of FIG. 10;

FIG. 13 is a perspective view of a web stock of another embodiment an envelope;

FIG. 14 is a top view of one of the envelopes shown in FIG. 13;

FIG. 15 depicts a web of walls, in an unfolded state, used to form the web stock shown in FIG. 13;

FIG. 16 depicts a web stock of another embodiment of an envelope that includes a flap closure;

FIG. 17 is a perspective view of another embodiment of an envelope with gusseted side walls;

FIG. 18 is a transverse cross-sectional view of another embodiment of an envelope;

FIG. 19 is a perspective view of a bagging machine configured to produce another embodiment of an envelope;

FIG. 20 is a perspective view of a web stock for use with the bagging machine shown in FIG. 19;

FIG. 21 is a perspective view of a web stock of side-loading envelopes with closure seals formed from a hot-melt adhesive; and

FIG. 22 is a side view of the envelope shown in FIG. 1 during the formation of a closure seal that closes and seals a pocket opening of the envelope.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts.

One having ordinary skill in the relevant art, however, will readily recognize that the inventive concepts can be practiced without one or more of the specific details or with other methods. In other instances, well-known structures or operation are not shown in detail to avoid obscuring the inventive concepts.

Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

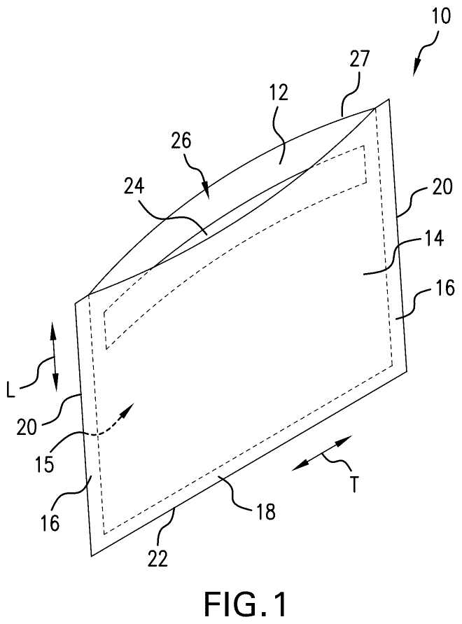

The present technology is directed to an item of parcel packaging having a closure seal formed from a reactivatable hot-melt material. FIGS. 1 to 4 depict an item of parcel packaging in the form of an envelope 10. This particular application is presented for illustrative purposes only. The disclosed technology can be applied to other types of parcel packaging.

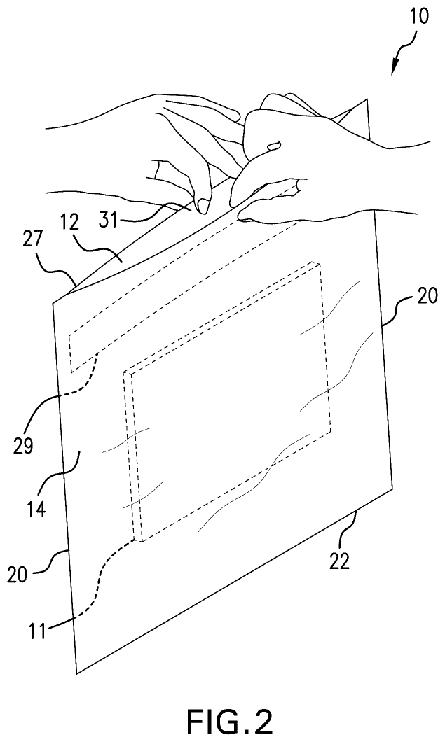

The envelope 10 is configured to contain and hold an item, typically enclosing the item, while the item is being mailed or shipped, or otherwise needs to be packaged in a closed container. The item held within the envelope 10 is depicted in phantom in FIG. 2, and is designated by the character 11.

The envelope 10 comprises an envelope body that includes a wall 12 and an opposing wall 14. The walls 12, 14 are formed from paper, and define an internal containment area or envelope pocket 15 that receives the item 11 being held or packaged within the envelope 10. The walls 12, 14 can be formed from a plastic film, in the alternative.

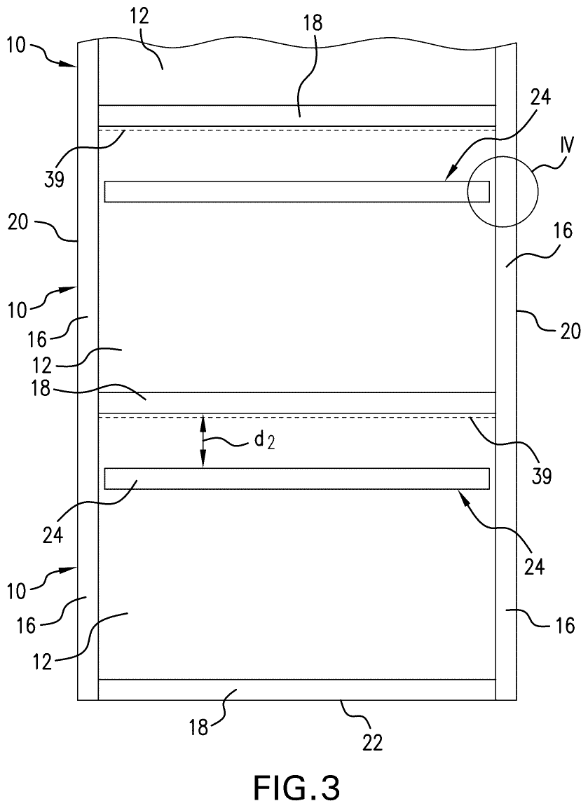

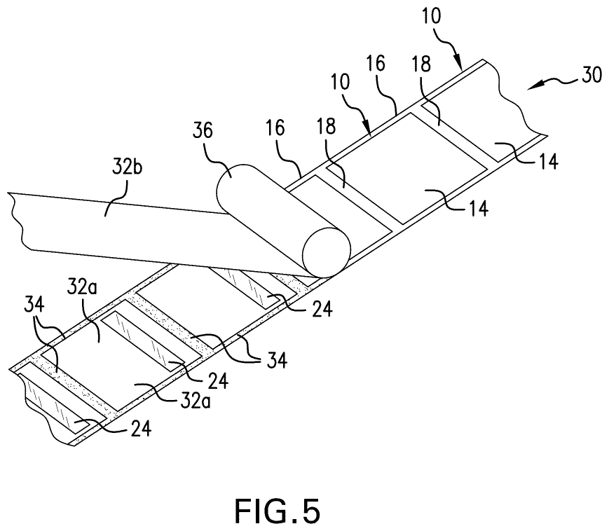

The envelope 10 also includes two inter-wall seals 16, and an inter-wall seal 18. The inter-wall seals 16, 18 are formed from a bonding element in the form of an adhesive material 34 depicted in FIG. 5. The inter-wall seals 16, 18 affix the walls 12, 14 to each other and define, in part, a pocket border of the envelope pocket 15. As can be seen in FIGS. 1 and 3, each inter-wall seal 16 is located along a respective side edge 20 of the envelope 10, and extends continuously in a longitudinal direction of the envelope 10, along the entire length of the side edge 20. The longitudinal direction is denoted in FIG. 2 by the arrow “L.” The inter-wall seals 16 can be offset from the side edges 20 of the envelope 10 in alternative embodiments. Also, the inter-wall seals 16 can extend over less than the entire length of the side edge 20, and/or can be non-continuous in alternative embodiments.

The inter-wall seal 18 extends continuously along the bottom edge 22 of the envelope 10, in a transverse direction, i.e., in a direction substantially perpendicular to the longitudinal direction, and intersects the inter-wall seals 16. The transverse direction is denoted in FIG. 2 by the arrow “T.” The inter-wall seal 18 can be offset from the bottom edge 22 of the envelope 10 in alternative embodiments. Also, the inter-wall seal 18 can extend over a distance less than the distance between the inter-wall seals 16, and/or can be non-continuous in alternative embodiments. In alternative embodiments, the inter-wall seal 18 can be formed by applying the adhesive material 34 along the bottom potion of the inner surface of the wall 12, and folding the bottom portion of the wall 12 over and onto the outer surface of the wall 14 to create a fold that reinforces the bottom of the envelope 10.

The inter-wall seals 16, 18 can extend in directions other than the longitudinal and transverse directions in alternative embodiments. Also, the inter-wall seals 16, 18 can extend non-linearly in alternative embodiments.

The inter-wall seals 16, 18 each can have a width of, for example, about 0.1 inch to about 0.5 inch. In other embodiments, the inter-wall seals 16, 18 each can have a width of, for example, about 0.25 inch. The inter-wall seals 16, 18 can have a width above or below these values in alternative embodiments.

Directional terms such as “top,” “bottom,” “upper,” “lower,” etc. are used in relation to the component orientations depicted in FIGS. 1 and 2. These terms are used for illustrative purposes only, and are not intended to limit the scope of the appended claims.

The adhesive material 34 can be a cold glue. In alternative embodiments, the inter-wall seals 16, 18, can be formed from other types of adhesives and bonding elements, including the following examples.

Examples of other adhesives suitable for use as the adhesive material 34 include liquid adhesives and pressure sensitive adhesives. Pressure sensitive adhesives can be selected that stick after applying a slight, initial, external pressure to create the bond. Examples of these include water-based, acrylic, pressure sensitive adhesives, similar to what is applied to packaging tape, which material holds two surfaces together solely by surface contact, often upon a slight initial external pressure. Other examples may include dry adhesives, which typically require no activation with water, solvent or heat, and firmly adhere to many dissimilar surfaces. Specific examples of water based, acrylic, pressure sensitive adhesives include those known as RHOPLEX™ N-1031 Emulsion, RHOPLEX™ N-580 Emulsion, and RHOPLEX™ N-619 Emulsion. Other emulsion polymers or acrylic polymer blend adhesives are also known, and other suitable types of adhesives and/or contact adhesives can be used.

A cohesive material is another example of a suitable adhesive material 34. A cohesive material includes a bonding material that causes one surface to stick to an opposing surface by coming into contact with the same or a complimentary cohesive substance to form the bond between the two surfaces. Cohesives do not stick to other substances sufficiently to adhere to those other substances, or in some cases stick very weakly compared to the bond they form.

A heat seal is an another example of a suitable adhesive material 34. A heat seal typically is formed by sealing one thermoplastic to the same or a similar thermoplastic. The heat seal material typically is applied to the two substrates to be affixed to each other. At the time the substrates are to be affixed, the heat seal material on one or both substrates is subject to heat and pressure sufficient to weld the heat seal materials together, thereby affixing the substrates to each other.

In some embodiments, the adhesive material 34 can include a polyolefin based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example HYPOD™, from Dow Chemical, or other suitable polyolefin dispersions.

In some embodiments, the adhesive material 34 can be water-based. The water-based adhesive material 34 may include a water-based polymer. The use of a water-based adhesive material 34 can enhance the recyclability of the envelopes 10, since the water-based adhesive material 34 can be dissolved and separated easily from the paper pulp during the recycling process.

The above examples of adhesive materials suitable for use as the adhesive material 34 are presented for illustrative purposes only. Other types of adhesive materials can be used in the alternative.

The walls 12, 14, after being affixed to each other in the above manner, define an opening 26 to the envelope pocket 15. As can be seen in FIG. 1, the opening 26 is located at the top of the envelope 10, and permits the item to be packaged 11 to be inserted into the envelope pocket 15. More specifically, the wall 14 overlies the wall 12 and is affixed to the wall 12 about at least a portion of a pocket border defined by the inter-wall seals 16, 18, with the pocket border enclosing the envelope pocket 15 defined between the walls 12, 14, and with at least one of the walls 14, 16 defining the opening 26 which allows access to the envelope pocket 15 from an exterior of the envelope 15 for loading an item 11 into the envelope pocket 15.

Referring to FIGS. 1-3, and 5, a closure-sealing element 24 is disposed on an inwardly-facing surface of the wall 12, i.e., on the surface of the wall 12 that faces the wall 14, proximate the upper end of the wall 12. The closure-sealing element 24, as discussed below, is heated and pressed to form a closure seal 29 that adheres the wall 14 to the wall 12, after the packaged item 11 has been loaded into the envelope pocket 15. The closure seal 29 thus maintains the opening 26 in a closed state, and forms another portion of the pocket border so that the pocket border completely circumscribes the envelope pocket 15 to retain the item 11 within the envelope pocket 15. The closure seal 29 is depicted in FIG. 2. Thus, prior to formation of the closure seal 29, the envelope pocket 15 is closed on three sides and open on the fourth side, with the fourth side being closed upon formation of the closure seal 29.

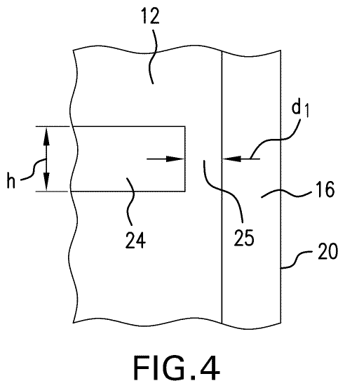

The closure-sealing element 24 extends in the transverse direction, between the inter-wall seals 16. Each end of the closure-sealing element 24 is spaced from a corresponding one of the inter-wall seals 16 by a distance “d₁” shown in FIG. 4, resulting in a gap 25 between each end of the closure-sealing element 24 and the corresponding inter-wall seal 16. As discussed below, the gaps 25 facilitate venting of the envelope pocket 15 as the envelope 10 is being sealed shut after the insertion of the item to be packaged 11 into the envelope pocket 15, so that the air pressure within the envelope pocket 15 can be equalized with the ambient air pressure. In alternative embodiments, the closure-sealing element 24 can extend to contact the inter-wall seal 16 on only one side of the closure-sealing element 24. In other alternative embodiments, venting can be provided by gaps in one or more of the inter-wall seals 16, 18. In other alternative embodiments, the closure-sealing element 24 can extend across the entire width of the wall 12, and gaps can be provided between the closure-sealing element 24 and the inter-wall seals 16, immediately below the closure-sealing element 24. In other alternative embodiments in which no vent is desired, the closure-sealing element 24 can extend to contact the inter-wall seals 16 on both sides the closure-sealing element 24, leaving no vents between the closure-sealing element 24 and the inter-wall seals 16.

The distance d₁ can be, for example, about 0.1 inch to about 0.5 inch. Other suitable values can be used, with d₁ can having a value above or below this range in alternative embodiments. As noted above, in some alternative embodiments, d₁ can be zero on one or both sides of the closure-sealing element 24, i.e., one or both ends of the closure-sealing element 24 can adjoin the adjacent inter-wall seals 16, so that one, or no vents are formed.

An upper edge of the closure-sealing element 24 is located below an upper edge of the wall 12 (which coincides with an upper edge 27 of the envelope 10) by a distance “d₂” shown in FIG. 3. The distance d₂ can be, for example, about 0.5 to about 2.0 inches. This value is presented for illustrative purposes only; d₂ can have a value above or below this range in alternative embodiments.

The height, or vertical dimension “h” of the closure-sealing element 24 is denoted in FIG. 4. The height h can be, for example, about 0.25 inch to about 0.75 inch. In alternative embodiments, the height h can be, for example, about 0.25 inch to about 1.0 inch. In other alternative embodiments, h can be, for example, 2.0 inches or less. The preceding values for the height h are presented for illustrative purposes only; h can have a value above or below these ranges in alternative embodiments.

The thickness of the closure-sealing element 24 can be, for example, about 0.5 mil to about 1.4 mil. In alternative embodiments, the thickness of the closure-sealing element 24 can be, for example, about 0.5 mil to about 0.75 mil. In other alternative embodiments, the thickness of the closure-sealing element 24 can be, for example, less than 1.0 mil. The preceding values are presented for illustrative purposes only, and can vary with factors such as the desired strength of the closure seal 29, the specific characteristics of the closure-sealing-sealing element 24, etc. Thus, the thickness of the closure-sealing element 24 can have other values in other alternative embodiments.

The closure-sealing element 24 is made from a low-tackiness hot-melt adhesive. More specifically, the hot-melt adhesive initially is in a low-tackiness state in which it has a low, or no tackiness in a lower range of temperatures, which includes room temperature. This lower range of temperatures in some embodiments is below about 140° F. In other embodiments, the lower range of temperatures is below about 120° F., below about 125° F., or below about 130° F.

The hot-melt adhesive from which the closure-sealing element 24 is formed is reactivatable. More specifically, the hot-melt adhesive is applied hot, and cools and cures in the converting process. It will not stick to other surfaces when cold because it has no, or minimal tackiness until it is reactivated, i.e., re-heated up to a sealable temperature above the lower range of temperatures at which the hot-melt adhesive initially is in a low-tackiness state. As noted above, this lower range of application temperatures includes room temperature, and in some embodiments is below about 140° F. In other embodiments, the lower range of temperatures is below about 120° F., below about 125° F., or below about 130° F.

The composition and preparation of the hot-melt adhesive provides its low-tackiness property prior to reactivation. In some embodiments, the tackiness at the lower range of temperatures would be sufficiently low such that the hot-melt adhesive is considered non-tacky, in which case no sticking together of the walls 12, 14 is detected by a user and the walls 12, 14 can separate under their own weight. Preferably, the level of tackiness of the hot-melt adhesive is sufficiently low so that any tacky adhesion between the walls 12,14 can be overcome easily by a user peeling the walls 12, 14 apart with their fingers using light force, and any tacky adhesion in various embodiments would be considered very light. In some embodiments, the level of tackiness between the walls 12, 14 is significantly weaker than the adhesion of a typical sticky note. Typically, the adhesive has sufficiently low tackiness so that the user pulling the walls 12, 14 apart will not notice significant adhesion between the walls 12, 14, and can pull the walls 12, 14 apart with a gentle force. In applications where the envelopes will be loaded and sealed by an automated bagging machine, any tackiness of the adhesive should be sufficiently low so that the walls 12, 14 can be separated readily by the machine using forced air, mechanical fingers, suction devices, or other techniques, i.e., any tackiness that may be present should not interfere with the proper operation of the bagging machine. Also, the strength of any tackiness holding the walls 12, 14 to each other is significantly lower than the strength of the material of the walls 12, 14 themselves, allowing the walls 12, 14 to be peeled apart, even if there were any detectable tackiness, without delaminating or otherwise damaging the walls 12,14. The walls 12, 14, therefore, will remain separated or separable from each other, and the opening 26 to the envelope pocket 15 will remain unsealed and capable of providing access to the envelope pocket 15 until the closure-sealing element 24 is reactivated.

The low-tackiness hot-melt adhesive from which the closure-sealing element 24 is formed typically is applied to the wall 12 in a molten state, and then cools and solidifies. Other suitable methods of application, such as the application of a strip of tape bearing the hot-melt adhesive, can be used in the alternative.

The selected hot-melt adhesive of the closure-sealing element 24 typically is a thermoplastic polymer adhesive that is solid at room temperature, becomes molten when heated to an activation temperature at or above its softening point, and resolidifies upon loss of heat at a temperature below a solidifying point, which may be the same as or different than the activation temperature, with the hot-melt adhesive increasing in strength as it re-solidifies. Some hot-melt adhesives can have minimal, or no tackiness when in their solid form, so that the hot-melt adhesive, after initially being applied to a substrate and cooling, does not bond or otherwise adhere to another substrate or object, or to the skin of a user coming into contact with the hot-melt adhesive. In applications in which a minimal degree of tackiness at room temperature or other temperature ranges is desired, tackifiers or tackifying agents can be added to the hot-melt adhesive in an amount sufficient to achieve the desired level of tackiness.

The hot-melt adhesive of the closure-sealing element 24, upon melting into a molten state and re-solidifying, does not undergo any chemical reaction such as cross-linking or removal of a carrier, e.g., evaporation of water. Thus, the hot-melt adhesive can be re-activated, i.e., heated so as to re-melt, followed by re-solidification, after initially being applied to the wall 12 or other substrate. As noted below, the hot-melt adhesive, upon re-melting and re-solidifying, can embed itself into the paper fibers of the wall 14, creating the bond strength that adheres the wall 14 to the wall 12.

The hot-melt adhesive used for the closure-sealing element 24 can be, for example, TECHNOMELT® 0370™ hot-melt adhesive available from Henkel Corporation. This particular type of hot-melt adhesive is disclosed for illustrative purposes only. Other types of hot-melt adhesives can be used in the alternative. As non-limiting examples, TECHNOMELT® 0437™ hot-melt adhesive; TECHNOMELT® 111PL™ hot-melt adhesive; and LOCTITE® ABELSTIK 8390 hot-melt adhesive, also available from Henkel Corporation, also can be used as the hot-melt adhesive. These adhesives are non-tacky at room temperature, and have no tackiness at or up to 120° F., to prevent sealing of wall 14 to the wall 12 before the envelope 10 is loaded and otherwise ready to be sealed.

Referring to FIG. 5, the envelope 10 can be formed as part of a continuous web stock 30 of multiple packaging containers 10. Individual packaging containers 10 subsequently can be separated from the web stock 30 by hand or by automated machinery, after the item 11 has been placed in the envelope pocket 15 and the opening 26 has been closed and sealed shut.

FIG. 5 depicts the manufacture of the web stock 30, using an automated device. More specifically, FIG. 5 shows two strips of paper 32a, 32b that, when joined in the following manner, form the walls 12, 14 of each envelope 10.

The adhesive material 34 is deposited on the paper strip 32a, at locations corresponding to the desired locations of the inter-wall seals 16, 18. More specifically, the adhesive material 34 is deposited continuously along the side edges of the paper strip 32a. Additional adhesive material 34 is deposited in transversely-extending bands spaced apart from each other along the length of the paper strip 32a, at locations corresponding to the locations of the inter-wall seals 18 of the envelopes 10 within the web stock 30.

Alternatively, the adhesive material 34 can be applied to the paper 32a, 32b by flood coating, followed by activation, e.g., the application of heat and/or pressure at the specific locations on the paper strips 32a, 32b at which the inter-wall seals 16, 18 are to be formed.

The bonding element, e.g., the adhesive material 34, can be applied directly to the exposed surfaces of the paper strips 32a, 32b by suitable known methods. Alternatively, the bonding element can be applied as a tape, such as a double-sided tape, or by other suitable methods.

The adhesive material 34 is heated to a molten flowable state and applied to the paper strip 32a in the molten state, and then is allowed to cure or reach room temperature before being brought into contact with the paper strip 32b as discussed below.

Also, the hot-melt adhesive from which the closure-sealing element 24 is formed is deposited on the paper strip 32a. The hot-melt adhesive is deposited in transversely-extending bands spaced apart from each other along the length of the paper strip 32a, at locations corresponding to the locations of the closure-sealing elements 24 on the envelopes 10 within the web stock 30.

The hot-melt adhesive is applied in a molten state, and is allowed to cool and re-solidify before the paper strips 32a, 32b are joined to form the web stock 30. For example, the hot-melt adhesive can be applied at a temperature of about 250° F. This particular temperature is presented for illustrative purposes only. The optimal temperature for the application of the hot-melt adhesive can vary with the specific type of hot-melt adhesive that is used.

As noted above, the hot-melt adhesive is a low-tackiness hot-melt adhesive that, prior to being reactivated, is in a low-tackiness state in which it has low, or no tackiness in a lower range of temperatures, including room temperature. Thus, once the hot-melt adhesive has cooled and re-solidified after initially being applied to the wall 12, the resulting closure-sealing element 24 will remain non-tacky or minimally-tacky, and will not adhere significantly to the wall 14 or to the item 11 being packaged in the envelope 10, until the hot-melt adhesive is reactivated by the application of heat and pressure to form the closure seal 29. Thus, prior to being loaded and sealed, the envelope 10 can assume a substantially flat state in which the opposing surfaces of the walls 12, 14 contact each other, and the closure-sealing element 24 contacts the adjacent surface of the wall 14 without adhering to the wall 14 to an extent that would prevent the walls 12, 14 from being readily separable at a later time to form the opening 26 to the envelope pocket 15. The envelope 10 thus can be shipped and stored in a relatively compact state, and without the need for a release layer on the closure-sealing element 24.

For example, in some embodiments, the closure-sealing element 24, prior to reactivation, i.e., before being heated and pressed to form the closure seal 29, can have a maximum peel strength of about 0.5 lb., and a minimum shear strength of about 0.5 lb. to about 2.0 lbs. In other embodiments, the closure-sealing element 24 can have a maximum peel strength of about 0.25 lbs., and a minimum shear strength of about 0.25 lbs. prior to reactivation. In other embodiments, the closure-sealing element 24 can have a maximum peel strength of about 0.1 lbs., and a minimum shear strength of about 0.1 lbs. prior to reactivation. In other embodiments, the closure-sealing element 24 can produce no detectable adhesion prior to reactivation. These values are presented for illustrative purposes only. The optimum values for the peel and shear strengths of the closure-sealing element 24 prior to reactivation are application-dependent, and can vary with factors such as the operating characteristics of any automated machinery that may used to load the envelope 10.

After the adhesive material 34 and the closure-sealing element 24 have been deposited on the paper strip 32a, the paper strip 32b is positioned above, and is aligned with the paper strip 32a. A roller 36 of the automated device then presses the paper strips 32a, 32b together, so that the adhesive material 34 on the paper strip 32a contacts the paper strip 32b, forming the inter-wall seals 16, 18 and securing the paper strips 32a, 32b to each other, resulting in the continuous web stock 30 of the packaging containers 10 shown in FIG. 5. In alternative embodiments, the adhesive material 34 can be deposited at corresponding locations on both of the paper strips 32a, 32b before the paper strips 32a, 32b are joined to form the web stock 30. Once the web stock 30 is formed, the upper edge 27 of each envelope 10 adjoins the bottom edge 22 and the inter-wall seal 18 of the adjacent envelope 10.

The opening 26 can be formed in each envelope 10 within the web stock 30 by making a kiss cut in the wall 14. Each kiss cut is made at a location corresponding to the upper edge 27 of the associated envelope 10. The kiss cut extends through, and continuously along the wall 14, but does not penetrate into the underlying wall 12, so that the adjacent packaging containers 10 remain attached to each other within the web stock 30 by way of the wall 12. Also, the kiss cut does not penetrate the inter-wall seals 16, so that the adjacent packaging containers 10 also remain attached to each other by way of the inter-wall seals 16. (As an alternative to a kiss cut, for example, the cut can be made in the sheet 32b before, or as the sheet 32b is joined to the sheet 32a to form the web 30.)

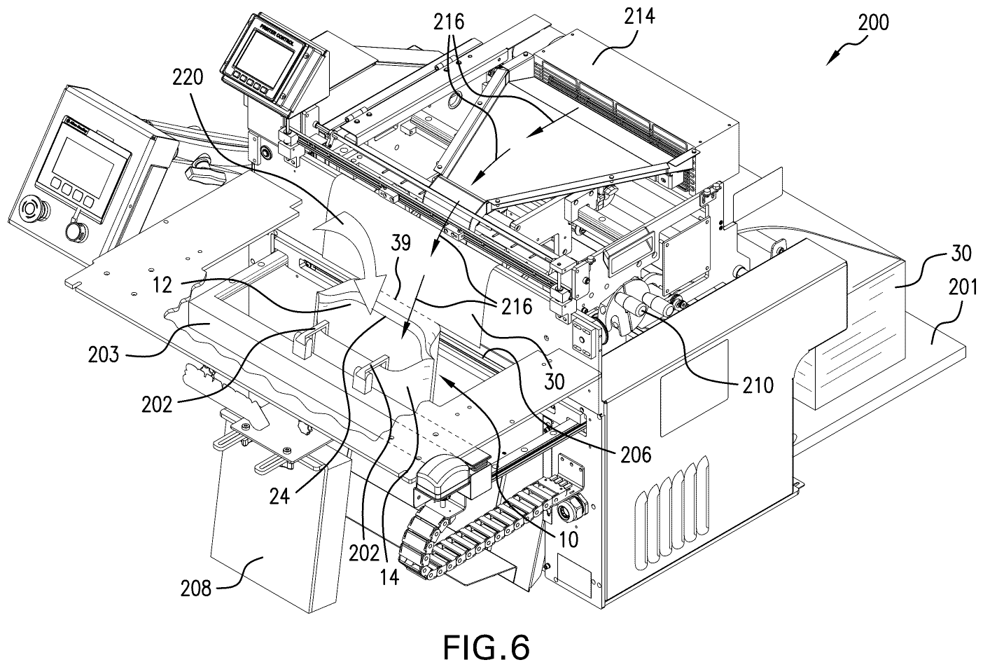

A region of weakness is formed in the wall 12, to facilitate separation of the individual packaging containers 10 from the web stock 30 after the item to be packaged 11 has been inserted into the envelope pocket 15 and the opening 26 has been closed and sealed. The region of weakness can be provided by perforations 39 formed in the wall 12, at locations corresponding to the upper edge 27 of the associated envelope 10. The perforations 39 thus are located at about the same vertical position on the envelope 10 as the kiss cut in the wall 14. In alternative embodiments, the perforations 39 can be formed in both the wall 12 and the wall 14, and can be slightly offset in the upward, i.e., upstream, direction in relation to the kiss cut in the wall 14. The perforations 39 are visible in FIGS. 3 and 6. The region of weakness, e.g., the perforations 39, may be placed as close as possible to the inter-wall seal 18 of the adjacent envelope 10 in the web stock 30, as shown in FIG. 3. For example, the perforations 39 can be spaced from the adjacent inter-wall seal 18 by about 0.1 inch to about 0.25 inch.

The perforations 39 can be configured to tear when subjected to a force of about 2.0 lbs. to about 5.0 lbs. For example, the perforations 39 can be configured with a 0.375-inch cut and a 0.032-inch tie, to produce a tear strength of about 4.45 lbs. per inch. The preceding values are presented for illustrative purposes only. The optimal values for noted parameters are application-dependent, and can vary with factors such as the size of the envelope 10 and the maximum anticipated load to be carried by the envelope 10.

The region of weakness can be provided by features other than the perforations 39 in alternative embodiments. For example, the region of weakness can be provided by scoring the wall 12. Other alternative embodiments can be formed without a region of weakness between adjacent packaging containers 10.

After the item 11 has been inserted into the envelope pocket 15, the closure-sealing element 24 can be reactivated by heating the closure-sealing element 24 to a temperature above the activation temperature of the hot-melt adhesive from which the closure-sealing element 24 is formed, and pressing the wall 14 onto the closure-sealing element 24 so that the hot-melt adhesive can soften or activate to begin adhering to the wall 14.

The holt-melt adhesive, upon cooling and re-solidifying, forms the closure seal 29 that bonds the wall 14 to the wall 12. Heat should be applied to the closure-sealing element 24 for a sufficient period of time to cause the molten hot-melt adhesive to be driven into the fibers of the underlying paper of the walls 12, 14, to help ensure that the resulting closure seal 29 has sufficient strength to affix the wall 14 to the wall 12. The closure seal 29 thus causes the now closed opening 26 to remain closed, which in turn seals the envelope pocket 15 and causes the item 11 within the envelope pocket 15 to be retained therein.

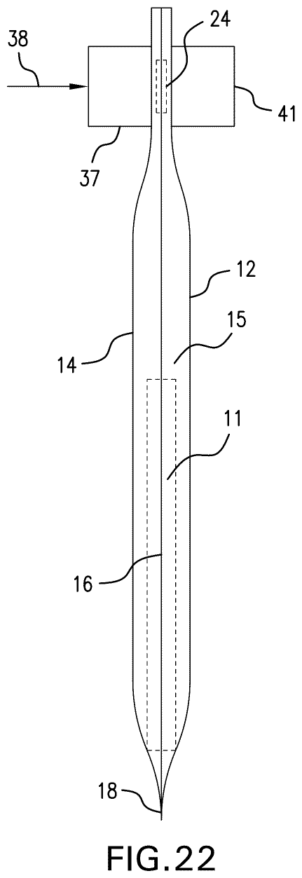

The closure-sealing element 24 can be heated and pressed against the wall 14 by, for example, a heated platen or sealing bar that heats and exerts pressure on the closure-sealing element 24 via the wall 14, in a highly focused, localized manner. Alternatively, as depicted in FIG. 22, the closure-sealing element 24 can be pressed against the wall 14 by press 37 configured to move into contact with the wall 14 in the direction denoted by the arrow 38. The press 37, upon being driven into contact with the wall 14, exerts pressure on the wall 14 and the adjacent closure-sealing element 24 and wall 12 to drive the wall 12 into contact with a heat sealer 41 located on the opposite side of the envelope 10 from the press 37. The heat sealer 41 heats the wall 12, and the heat is transferred to the closure-sealing element 24 via the wall 12.

The temperature to which the closure-sealing element 24 is heated should be sufficiently high to transition the hot-melt adhesive of the closure-sealing element 24 to a molten state, i.e., the temperature should be high enough to transfer sufficient heat through the wall 14 to raise the temperature of the closure-sealing element 24 above the activation temperature of the hot-melt adhesive. The temperature to which the closure-sealing element 24 is heated should be low enough, however, to avoid burning or charring the paper from which the walls 12, 14 are formed, considering that the heat is directly applied to, and must transfer through the wall 12 in order to reach the closure-sealing element 24. For example, the heat sealer 41 (or other heat source) can be heated to a temperature of about 350° F. to about 390° F., and the press 37 can be pressed against the wall 14 for about 0.25 second to about 0.75 second while the press 37 exerts a pressure of about 1.3 psi to about 12 psi on the wall 14. In other embodiments, the heat sealer 41 can be heated to a temperature of about 350° F. to about 390° F., and the press 37 can be pressed against the wall 14 for about 0.25 second to about 0.75 second while exerting a pressure of about 1.3 psi to about 2.5 psi on the wall 14. In other embodiments, the heat sealer 37 can be heated to a temperature of about 250° F. to about 350° F., and the press 37 can be pressed against the wall 14 for about 0.25 second to about 1.0 second while exerting a pressure of about 1.3 psi to about 2.5 psi on the wall 14. In other embodiments, the heat sealer 41 can be heated to a temperature of about 380° F., and the press 37 can be pressed against the wall 14 for about 0.3 second while exerting a pressure of about 90-120 psi on the wall 14. In other embodiments, the heat sealer 41 can be heated to a temperature of about 380° F., and the press 37 can be pressed against the wall 14 for about 0.3 second while exerting a pressure of about 110 psi on the wall 14. These particular combinations of temperature range, heating time, and pressure are presented for illustrative purposes only. The optimal temperature range, heating time, and pressure are application dependent, and can vary with factors such as the softening point of the hot-melt adhesive, the type and thickness of the paper or other material from which the wall 12 is formed, etc.

Alternatively, the closure-sealing element 24 can be heated by a radiative heat source; by directing heated air at the closure-sealing element 24; or by other suitable techniques.

Because the heat applied to the closure-sealing element 24 is transferred through the wall 12, the applied heat should be sufficient to adequately soften the closure-sealing element 24, without burning or charring the paper or other material from which the wall 12 is formed. Due to the relatively low activation temperature of the hot-melt adhesive of the closure-sealing element 24, in comparison to heat seal adhesives, the risk of charring or otherwise burning the paper or other material is relatively low. For example, the above exemplary temperature ranges for heating the closure-sealing element 24 are well below 450° F., the approximate ignition temperature of many types of paper. Thus, the closure seal 29 can be formed from the closure-sealing element 24 without adversely affecting the envelope 10 or its contents.

The width, i.e., vertical dimension, of the press 37 can be, for example, about 0.25 inch to about 0.75 inch. In alternative embodiments, the width of the press 37 can be, for example, about 0.25 inch to about 1.0 inch. These particular values are presented for illustrative purposes only. For example, the greater overall force applied with a wider press 37 more effectively pushes the molten hot-melt adhesive of the closure-sealing element 24 into the wall 14 and embeds the molten hot-melt adhesive in the fibers of the wall 14, which can result in a fiber tear between the closure seal 29 and the underlying paper when the envelope 10 subsequently is opened.

The gaps 25 between the ends of the strip of closure-sealing element 24 and the inter-wall seals 16 facilitate venting of the envelope pocket 15 as the closure-sealing element 24 is heated, thereby preventing heated air from being trapped within the envelope pocket 15, expanding, and rupturing or otherwise damaging the inter-wall seals 16, 18 or other parts of the envelope 10. Such air may be excess air that becomes trapped during the insertion of the item 11 in the envelope pocket 15, and/or air within the envelope pocket 15 that is caused to expand due to the heat from the sealing process. In alternative embodiments, venting of the envelope pocket 15 can be provided by other features such a gaps within, or between the inter-wall seals 16, 18; cuts or holes in the wall 12 and/or the wall 14, etc.

As discussed above, an upper edge of the closure-sealing element 24 is located below the upper edge 27 of the envelope 10 by the distance “d₂” shown in FIG. 3. Thus, the closure seal 29, once formed, is offset from the upper edge 27 by a similar distance. The portions of the walls 12, 14 above the closure seal 29 form a skirt 31, shown in FIG. 2.

When a user wishes to remove the item 11 from the envelope pocket 15, the user can access the envelope pocket 15, and the item 11 therein by, for example, grasping the skirt 31, i.e., by grasping the uppermost portions of the walls 12, 14, and pulling the walls 12, 14 in opposite directions, as shown in FIG. 2. This action breaks the closure seal 29, and re-opens the opening 26, allowing the user to access the envelope pocket 15 and the item 11 residing therein. The above-noted offset between the upper edge 27 of the envelope 10 and the upper edge of closure-sealing element 24, i.e., the distance d₂, can permit the user to exert a firm grip on each of the walls 12, 14, so that the user can exert a substantial pulling force on the walls 12, 14, in opposite directions.

In some embodiments, the closure seal 29, once formed by the reactivation of the hot-melt adhesive, can have a minimum peel strength of about 1.0 lb., and a minimum shear strength of about 1.0 lb. In other embodiments, the closure seal 29 can have a minimum peel strength of about 0.5 lb. to about 2.0 lbs., and a minimum shear strength of about 3.0 lbs. The preceding values are presented for illustrative purposes only. The optimum values for the peel and shear strengths of the closure seal 29 are application-dependent, and can vary with factors such as the size of the envelope 1; the maximum anticipated load to be carried by the envelope 10; etc.

The strength of the closure seal 29 can be determined by factors such as the shape and size of the closure-sealing element 24; the characteristics of the hot-melt adhesive from which the closure-sealing element 24 is formed; and the characteristics of the paper or other material from which the walls 12, 14 are formed. In some embodiments, the bond between the closure-sealing element 29 and the underlying paper is the weak point that fails when the envelope 10 is opened.

In other embodiments, the closure-sealing element 29 itself could fail before the bond between the closure-sealing element 29 and the paper. In other embodiments, the closure-sealing element 29, and its bond with the paper can be stronger than the paper, so that the paper delaminates or tears as the envelope 10 is opened. For example, the occurrence, and extent of fiber tear in the paper is dependent upon the width, i.e., vertical dimension, of the closure-sealing element 29, with a wider closure-sealing element 29 providing more paper fiber to which the closure-sealing element 29 can adhere, which in turn strengthens the bond between the closure-sealing element 29 and the paper and encourages delamination or tearing of the paper. In other embodiments, a combination of the above can occur as the envelope 10 is opened.

The envelopes 10 can be loaded, sealed, and separated from the web stock 16 by a bagging machine 200 depicted in FIG. 6. The bagging machine 200 is described for illustrative purposes only. The envelopes 10 can be loaded, sealed, and separated from the web stock 30 manually, and by other automated means in the alternative.

The web stock 30 is fed into the bagging machine 200 in an unexpanded, high-density configuration. As shown in FIG. 6, the web stock 16 can be held on a shelf 201 mounted on the supply side of the bagging machine 200. The web stock 30 can be supplied in a fanfold configuration, a rolled configuration, and other suitable configurations.

The bagging machine 200 includes an opening device, in the form of fingers 202, that is configured to open the envelope 10 to provide access to the envelope pocket 15, so that the item to be packaged 11 can be loaded into the envelope 10. The fingers 202 are configured to grasp and pinch an upper portion of the wall 14. The fingers 202 are mounted on a press in the form of, for example, an articulating jaw 203 that can move outwardly and inwardly, i.e., away from and toward the web stock 16 from the perspective of FIG. 6.

The fingers 202 initially grasp and pinch the wall 14 when the articulating jaw 203 is in its inward position, so that outward movement of the articulating jaw 203 and the attached fingers 202 pulls the wall 14 away from the wall 12 to form the opening 26 at the top of the envelope 10. As noted above, the low (or zero) tackiness of the closure-sealing element 24 permits the wall 14 to be pulled away from the wall 12 without significant resistance from the closure-sealing element 24. As can be seen in FIG. 6, the outward movement of the wall 14 causes some of the perforations 39 to tear, to accommodate the resulting expansion of the envelope 10.

The bagging machine 200 can include an air blower 214 configured to direct pressurized air at the top of the envelope 10 as denoted by the arrows 216, to aid in separating the walls 12, 14. Once the opening to the envelope pocket 12 has been formed, the item to be packaged 11 can be loaded into the envelope pocket 15 manually, or by automated machinery, as denoted by the arrow 220.

The above-noted offset between the upper edge 27 of the envelope 10 and the closure-sealing element 24 can make it easier for the fingers 202, and the pressurized air produced by the blower 214, to enter the space between the walls 12, 14.

The opening device can have a configuration other than the fingers 202 in alternative embodiments. For example, articulating suction cups can be used as the opening device in alternative embodiments. In other alternative embodiments, the pressurized air from the air blower 214 can be used to open the envelope 10. In other alternative embodiments, the envelope 10 can be opened manually, without the use of an opening device.

The bagging machine 200 further includes a heat sealer 206. After the item 11 has been loaded into the envelope pocket 15, the articulating jaw 203 moves the wall 14, which is still being in grasped and pinched by the fingers 202, inwardly, toward the wall 12.

The inward movement of the articulating jaw 203 and the wall 14 eventually causes the walls 12, 14 and the closure-sealing element 24 to become sandwiched between the articulating jaw 203 and the heat sealer 206. The heat sealer 206 heats the closure-sealing element 24 while urging the closure-sealing element 24 against the wall 12, so that the molten hot-melt adhesive of the closure-sealing element 24, upon cooling an re-solidifying, forms the closure seal 29 that seals the envelope pocket 15 and prevents the packaged item from exiting the envelope pocket 15. The sealed envelope 10 is depicted in FIG. 2.

The bagging machine 200 can be equipped with a pad 208, for example, that is mounted on, and moves with the articulating jaw 203, or with another mechanism to compress or squeeze the envelope 10, such as when the articulating jaw 203 moves inward, to help drive air out of the envelope pocket 12 before the envelope pocket 15 is sealed. In embodiments that include internal venting, such as the envelope 10, this step can occur at a later point in the bagging process, or can be omitted entirely. The bagging machine 200 also can include a label printer 210 configured to print a label, and affix the label to the envelope 10.

After the envelope 10 has been loaded and sealed, the envelope 10 is separated from the web stock 30. In particular, the articulating jaw 203 and the heat sealer 206 continue to grasp the envelope 10 as upstream rollers (not shown) pull back on the web stock 300 located upstream of the envelope 10, to separate the envelope 10 from the web stock 300 along the region of weakness formed by the perforations 39. In alternative embodiments, the separation can be achieved other means such as a cutting mechanism; a device that applies focused heat along the line of separation; etc.

Once the loaded envelope 10 is separated from the web stock 30, the envelope 10 can drop onto a conveyor (not shown) or other means for transporting or holding the envelope 10. In alternative embodiments, the walls 12, 14 can be formed unitarily from a single

webbing that is folded onto itself so that the wall 14 overlies the wall 12. One inter wall seal 16 can be used to affix the overlying longitudinally-extending edges of the webbing to each other. One interwall seal 18 likewise can be used to affix the overlying transversely-extending edges of the webbing 14 to each other at the bottom end of the envelope.

In alternative embodiments, one or both of the walls 12, 14 can include one or more functional layers positioned thereon. Examples of functional layers can include, but are not limited to, waterproofing layers (configured to reduce permeability of water therethrough), an airtight layer (configured to reduce permeability of air therethrough), other suitable material layers, and/or a combination thereof.

Examples of paper suitable for use in forming the walls 12, 14 include, but are not limited to, kraft paper, fiberboard, pulp-based paper, recycled paper, and newsprint. In some applications, the paper may be an extensible paper configured to elongate, or stretch, by up to a predetermined percentage of its original (unstretched) length, without tearing. Parameters of the paper, including its dimensions and weight, may be varied depending upon the desired application. For example, the walls 12, 14 each can be formed from a single ply of 55-pound (ream weight) SPX® extensible Kraft paper available from Canadian Kraft Paper Industries Ltd. of Manitoba, Canada. This particular type of paper is specified for illustrative purposes only. Other types of paper can be used in alternative embodiments. For example, the walls 12, 14 each can be formed from a single ply of 30 to 90-pound SPX® extensible Kraft paper, depending on the degree of strength of the walls 12, 14 required for a particular application.

In other alternative embodiments, one or both of the walls 12, 14 can have a multi-ply configuration. For example, the walls 12, 14 each can be formed from two plies of relatively low basis-weight paper, such as two plies of 30 to 45-pound paper. The two plies of 30-pound to 45-pound paper can be used, for example, in lieu of a single ply of 90-pound paper.

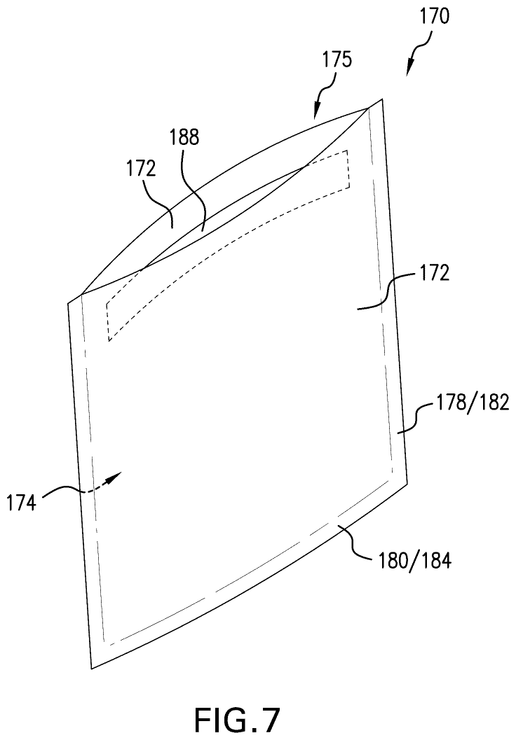

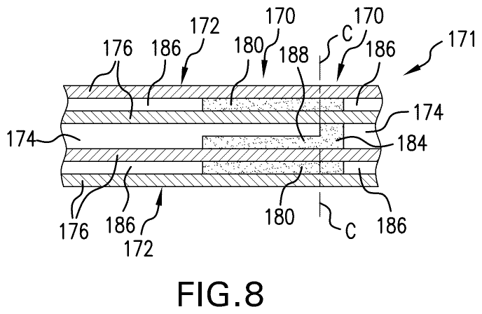

For example, FIGS. 7 and 8 depict an alternative embodiment in the form of an envelope 170. The envelope 170 comprises an envelope body that includes two flexible walls 172 joined so as to define an internal containment area or envelope pocket 174 configured to receive and hold an item. Each wall 172 is formed from two layers or plies 176 of paper.

The plies 176 of each wall 172 are joined to each other by one or more inter-ply seals. The inter-ply seals include a bonding element, such as the adhesive material 34 discussed above, positioned on at least one of the opposing surfaces of the plies 176. The inter-ply seals can include one or more inter-ply seals 178 located on, or adjacent to a corresponding longitudinal edge of the respective plies 176. The inter-ply seals also may include one or more inter-ply seals 180 extending transversely between the inter-ply seals 178 and/or the longitudinal edges of the plies 176.

The inter-ply seals 178, 180 border, and help to define an interlayer region, or inter-ply space 186 between the two plies 176 of each wall 172. The inter-ply space 186 is visible, in part, in FIG. 8.

The two plies 176 of each wall 172 face each other each other across the inter-ply space 186, but are not adhered to each other in the inter-ply space 186. Also, the inter-ply space 186 is sufficiently empty such that the plies 172 can abut and otherwise contact each other within the inter-ply space 186, and can slide in relation to each other within the inter-ply space 186. For example, the inter-ply space 186 can be completely empty, i.e., the inter-ply space 186 can be completely devoid of any filler or other material.

The walls 172 are joined together by a plurality of inter-wall seals. The inter-wall seals can be formed from a bonding element, such as an adhesive material, deposited on one or both of the walls 172. The inter-wall seals may include inter-wall seals 182 that extend substantially in a longitudinal direction, and inter-wall seals 184 that extend substantially in a transverse direction. The inter-wall seals 182, 184 border an envelope pocket 174 or containment region defined by the walls 172, and thus define a pocket border. As can be seen in FIG. 8, the interlayer region or inter-ply space 186 overlies the envelope pocket 174.

The inter-wall seals 182, 184 can extend in directions other than the longitudinal and transverse directions in alternative embodiments. Also, the inter-wall seals can extend non-linearly in alternative embodiments.

The walls 172 define an opening 175 that permits the item 11 to be packaged to be inserted into the envelope pocket 174. A closure-sealing element 188, formed from a hot-melt adhesive as discussed in relation to the envelope 10, is disposed on an inwardly-facing surface of one the walls 172, at or near the opening 175, as discussed above in relation to the envelope 10.

The closure-sealing element 188 can be reactivated after an item to be packaged has been inserted into the envelope pocket 174, to form a closure seal that affixes the walls 172 to each other. The closure seal maintains the envelope pocket 174 in a closed state so that the packaged item is retained within the envelope pocket 174.

FIGS. 6 and 7 depict the closure-sealing element 188 located directly adjacent the top of the envelope 170. The closure-sealing element 188 can be offset from the top of the envelope 170 in alternative embodiments.

After the opening 175 has been sealed, the sealed envelope 170 can be separated from the adjacent envelope within a web stock 171 of the envelopes 170, as discussed above in relation to the envelope 10. The separation can occur along a line of separation C that extends through the walls 172, and between the closure-sealing element 188 and the inter-wall seal 184 of the adjacent envelope 170 within the web stock 171. The line of separation, and a portion of the web stock 171 are shown in FIG. 8.

In alternative embodiments, a cushioning, padding, and/or thermally-insulting material, or other types of expandable and non-expandable materials can be disposed in in the inter-ply space 186 of the envelope 170. For example, a foam padding material can be disposed in the inter-ply space 186.

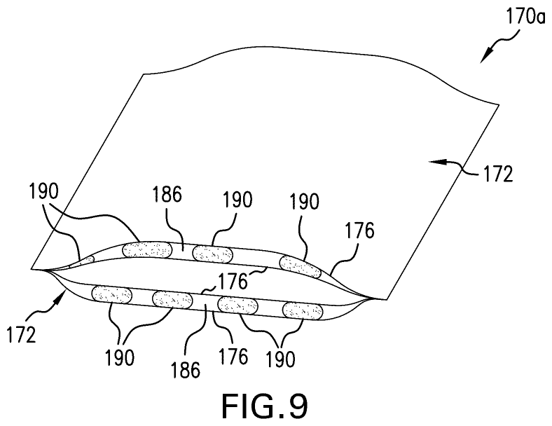

As another example, FIG. 9 depicts an envelope 170a that is substantially identical to the envelope 170, with the exception that the envelope 170a includes an expansion material 190 disposed in the inter-ply space 186 and adhered to the adjacent plies 176. The expansion material 190 is configured to assume an expanded configuration upon activation by an expansion initiator. The expansion initiator can be, for example, thermal, mechanical, and/or chemical, and/or can include other suitable initiating properties for activating the expansion material. The expansion material 190, in its expanded state as shown in FIG. 9, can provide the envelope 170a with cushioning, thermally-insulative, or other properties. The expansion (or other) material should not overlie the hot-melt adhesive (discussed below) that affixes the walls 172 to each other, to avoid excessive heating of the expansion material and/or insufficient heating of the hot-melt adhesive.

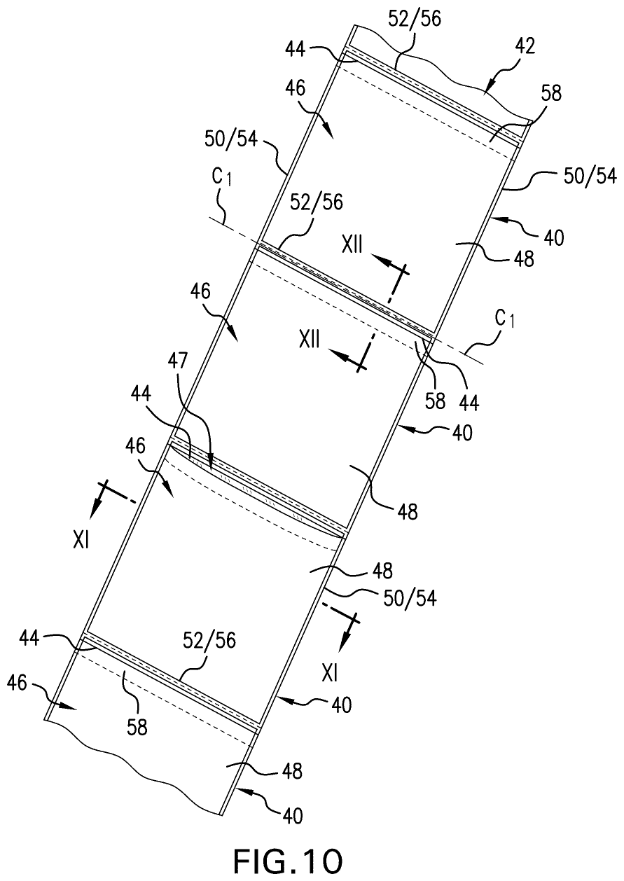

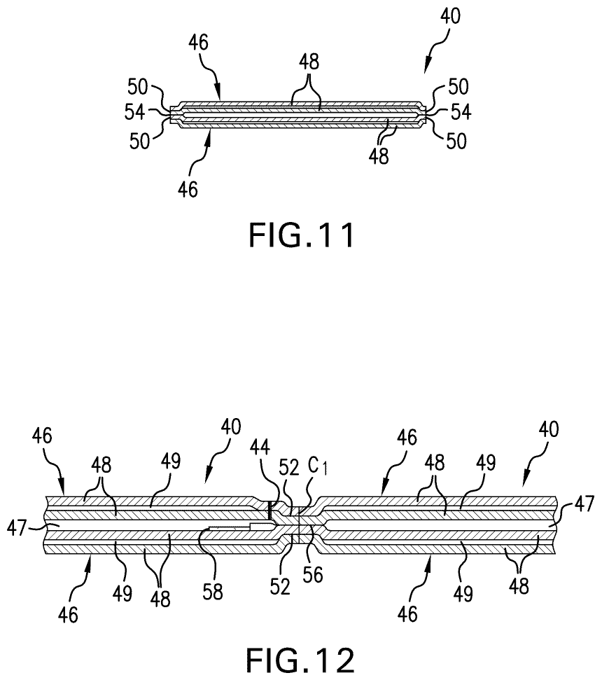

FIGS. 10-12 depict an alternative embodiment in the form of an envelope 40. FIG. 10 shows a web stock 42 of adjoining envelopes 40. The envelopes 40 are similar to, and can be formed in a manner similar to the envelopes 170, with the exception that each envelope 40 has a slit 44 extending transversely across one wall 46 of the envelope 40, to provide access to an internal containment area in a form of an envelope pocket 47. More specifically, the envelope 40 includes two of the walls 46. Each wall 46 comprises two plies 48 of a paper material. The slit 44 is formed in both plies 48 of a first of the walls 46, as can be seen in FIG. 11.

The plies 48 of each wall 46 are joined by inter-ply seals 50 located at or near the sides of the wall 46 and depicted in FIG. 11, and by inter-ply seals 52 located at the top and bottom of each wall 46 and depicted in FIG. 12. The inter-ply seals 50 and the inter-ply seals 52 can be formed in a manner similar to the inter-ply seals 18 and the inter-ply seals 20 of the envelope 10. In alternative embodiments, one of the walls 46 can be formed from a single ply 48. As shown in FIG. 12, the plies 48 of each wall 46 define an inter-layer region in the form of an inter-ply space 49 therebetween.

The walls 46 are joined by inter-wall seals 54 located at sides of the envelope 40 and depicted in FIG. 11, and by inter-wall seals 56 located at the top and bottom of each wall 46 and depicted in FIG. 12. The inter-wall seals 54, 56 can be formed in a manner similar to the inter-wall seals 14, 16 of the envelopes 10.

The opposing walls 46 define the envelope pocket 47. As can be seen in FIG. 12, the slit 44 formed in the first of the walls 46 provides access to the envelope pocket 47. The slit 44 is located directly below the inter-ply seal 54 of the wall 46, i.e., the slit 44 is located directly to the left of the inter-ply seal 54, from the perspective of FIG. 12. In alternative embodiments, the slit 44 can be offset from the inter-ply seal 54 in the longitudinal direction. The slit 44 extends continuously over a substantial entirely of the width of the wall 46, but stops short of the inter-ply seals 50 and the inter-wall seals 54. In alternative embodiments, the slit 44 can be non-continuous, and/or can extend over a less than a substantial entirety of the associated wall 46. In other alternative embodiments, a slit 44 can be formed in each of the walls 46.

A closure-sealing element 58 in the form of a hot-melt adhesive as discussed above in relation to the envelope 10 is disposed on an inwardly-facing surface of the inner ply 48 of a second of the walls 46, at or near the top of the wall 46. The closure-sealing element 58 can be disposed on an inwardly-facing surface of the inner ply 48 of the first wall 46, i.e., the wall 46 with the slit 44 formed therein, in alternative embodiments.

As noted above, the envelope pocket 47 can receive an item to be packaged within the envelope 40. Due to the flexibility of the paper walls 46, the envelope 40 can be stored and shipped in a substantially flat, compact configuration in which the envelope pocket 47 has minimal, or substantially zero volume. When the user desires to load an item into the envelope 40, the user can expand the envelope pocket 47 by separating or pulling apart the walls 46 at or near the top of the envelope pocket 47, and inserting the item be packaged through the opening defined by the slit 44. Once the item has been placed in the envelope 40, the closure-sealing element 58 can be heated, and pressure can be applied to press the closure-sealing element 58 into the first of the walls 46, to form a closure seal that affixes the walls 46 to each other. The closure seal maintains the envelope pocket 47 in a closed state so that the packaged item is retained within the envelope pocket 47.

The envelope 40 can be separated from the web stock 42 as discussed above in relation to the envelope 10. The separation can occur along a line of separation denoted in FIGS. 10 and 12 by the line “C₁.” The line of separation C₁ extends through the walls 46, the inter-ply seals 52, and the inter-wall seal 56. As can be seen in FIG. 10, the line of separation C₁ is longitudinally offset from the slit 44.

Once the envelope 40 has been separated from the web 42, the portions of the walls 46, the inter-ply seals 52, and the inter-wall seal 56 below the line of separation C₁, i.e., to the left of the line of separation C₁ from the perspective of FIG. 12, form the upper end of the envelope 40. The portions of the walls 46, the inter-ply seals 52, and the inter-wall seal 56 above the line of separation C₁, i.e., to the right of the line of separation C₁ from the perspective of FIG. 12, form the lower end of the adjacent envelope 10 which is still attached to the web stock 42.

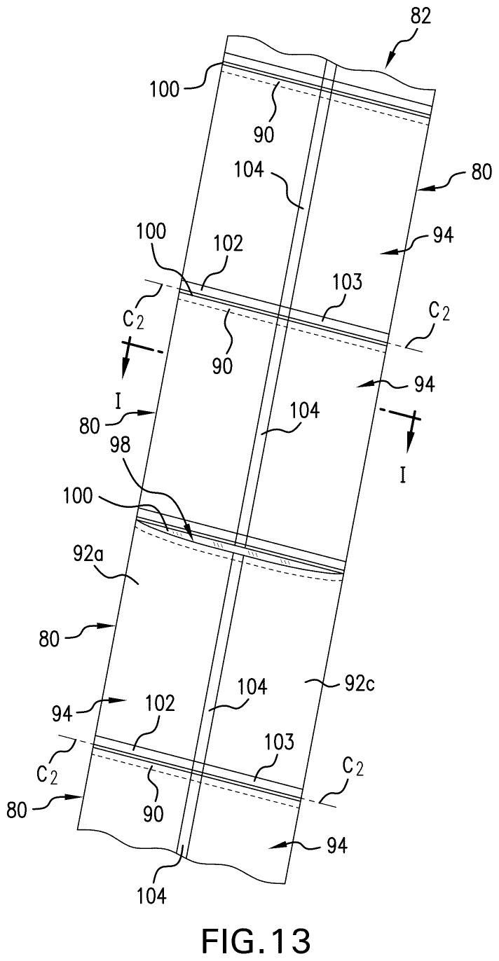

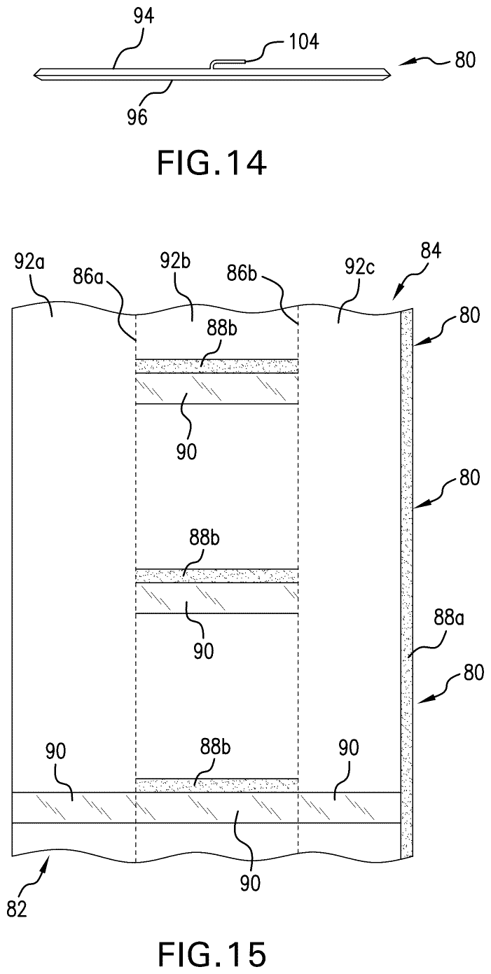

FIGS. 13-15 depict another in the form of an envelope 80. The envelope 80 is depicted as part of a web stock 82 of the envelopes 80. The web stock 82 is formed from a two-ply web 84 depicted in FIG. 15. The web 84 comprises two plies of material joined by inter-ply seals (not shown) so as to form an un-filled inter-layer region or inter-ply space between the plies, as discussed above in relation to the envelope 170. The web 84 can be formed from a single ply in alternative embodiments. In other alternative embodiments, the two-ply web 84 can have expandable or non-expandable padding, cushioning and/or thermally insulating material disposed between the plies.

The web stock 82 is formed from the web 84 by folding the web 84 along fold lines 86a, 86b denoted in FIG. 15. The fold lines 86a, 86b define a first segment 92a of the web 84 located to the left the fold line 86a; a second segment 92b located between the fold lines 86a, 86b; and a third segment 92c located to the right of the fold line 86b.

As can be seen in FIG. 15, an adhesive material 88a is disposed on an outer surface of the web 84, along a longitudinally-extending edge of the third segment 92c. Additional adhesive material 88b is disposed on the outer surface of the web 84, between the fold lines 86a, 86b. The adhesive material 88b extends in a transverse direction, and is positioned at multiple locations along the length of the webbing 82.

The web stock 82 is formed by folding the first segment 92a of the web 84 about the fold line 86a, and onto on the second segment 92b. The folding of the first segment 92a causes the first segment 92a to contact the adhesive material 88b on the second segment 92b, forming an inter-wall seal 102 between the first and second segments 92a, 92b.

The third segment 92c of the web 84 subsequently is folded about the fold line 86b. The folding of the third segment 92c causes the third segment 92c to contact the adhesive material 88b on the second segment 92b, forming an inter-wall seal 103 between the second and third segments 92b, 92c. The folding of the third segment 92c also causes the adhesive material 88a on the third segment 92c to contact a longitudinally-extending edge of the first segment 92a, forming an inter-wall seal 104 between the first and third segments 92a, 92b.

The inter-wall seals 102, 103, 104 affix the first, second, and third segments 92a, 92b, 92c to each other so that each packaging container 80 within the web stock 82 retains the double-folded configuration depicted in FIG. 13. The first and third segments 92a, 92c, once joined, form a first wall 94 of the packaging container 80. The second segment 92b forms an opposing wall 96 of the packaging container 80, visible in FIG. 13. The walls 94, 96 define an internal containment area or envelope pocket 98 of the packaging container 80. The envelope pocket 98 is partially visible in FIG. 13.

As can be seen in FIG. 15, a closure-sealing element 90, formed of a hot-melt adhesive as discussed above in relation to the envelope 10, is disposed on the second segment 92b of the web 84. The closure-sealing element 90 extends transversely across the second segment 92b, and is located in part directly below the adhesive material 88b. The ends of the closure-sealing element 90 can be spaced from the respective fold lines 86a, 86b, to facilitate venting of the envelope pocket 98 during activation of the hot-melt adhesive from which the closure-sealing element 90 is formed. The envelope pocket 98 can be vented by other provisions in alternative embodiments. The envelope pocket 98 can be non-vented in other alternative embodiments. The closure-sealing element 90 can be disposed on the first and third segments 92a, 92c of the web 84 instead of the second segment 92b, in other alternative embodiments.

A slit 100 is formed in the first wall 94, as shown in FIG. 13. The slit 100 is located directly above the closure-sealing element 90, i.e., the slit 100 is located between the closure-sealing element 90 and the adjacent inter-wall seals 102, 103.

An individual envelope 80 can be separated from the web stock 82 as discussed above in relation to the envelopes 10. The line of separation can be located between the closure-sealing element 90 and the inter-wall seals 102, 103 bordering the closure-sealing element 90. The line of separation of is denoted in FIG. 13 by the line “C₂.”

To load an item into the envelope 80, the user can expand the envelope pocket 98 by separating or pulling apart the walls 94, 96 at or near the top of the envelope pocket 98, and inserting the item be packaged between the walls 94, 96. Once the item has been placed in the packaging container 80, the closure-sealing element 90 can be activated, i.e., heated and pressed together, so that the hot-melt adhesive of the closure-sealing element 90, upon cooling, forms a closure seal that affixes the walls 94, 96 to each other. The closure seal maintains the envelope pocket 98 in a closed state so that the packaged item is retained within the envelope pocket 98.

Alternative embodiments of the envelope 80 can be formed by folding the web 84 along a single fold line that divides the web 84 into two segments, so that the respective longitudinal edges of the two segments are joined by a longitudinally-extending inter-wall seal; one of the segments forms an entirety a first wall of the packaging container; and a second of the segments forms an entirety an opposing second wall of the packaging container.

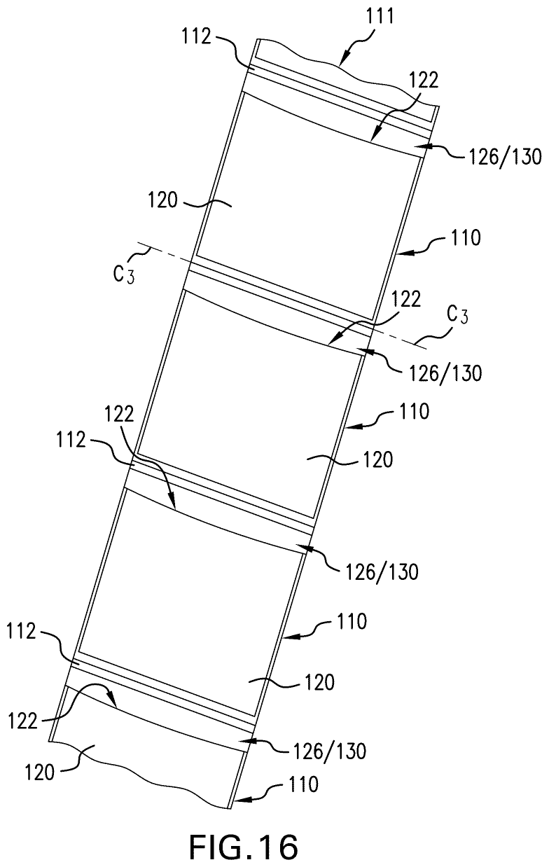

FIG. 16 depicts another embodiment in the form of an envelope 110 that includes a flap 130, and closure-sealing element 112 formed from a hot-melt adhesive as discussed above in relation to the envelope 10. The envelopes 110 are depicted as part of a web stock 111 of adjoining envelopes 110. The envelope 110 may be formed with the features of any of the above-described envelopes.

The envelope 110 incudes a front wall 120, and a back wall 126 that opposes, and is affixed to the front wall 120. The front wall 120 and the back wall 126 define an opening 122 that provides access to an internal containment area or envelope pocket of the envelope 110.

The closure-sealing element 112 is disposed on the uppermost portion of the back wall 126, as can be seen in FIG. 16. The closure-sealing element 112 is depicted as being longitudinally offset from the opening 122. In alternative embodiments, the closure-sealing element 112 can border the opening 122.

The portion of the back wall 126 visible in FIG. 16 forms the flap 130. The envelope 110 can be separated from the adjacent envelope 110 within the web stock 111 along a line of separation C₃ shown in FIG. 16. After an item, such as the item 11, has been inserted into the envelope pocket of the separated envelope 110 through the opening 122, the flap 130 can be folded over, and onto the front wall 120 so that the flap 130 covers the opening 122 and the closure-sealing element 112 is brought into contact with the front wall 120. The closure-sealing element 112 can be activated to form a closure seal that affixes the flap 130 to the front wall 120. The closure seal thereby maintains the envelope pocket in a closed state so that the packaged item is retained within the envelope pocket.

In alternative embodiments, the closure-sealing element 112 can be disposed on the front wall 120 instead of the flap 130. In this embodiment, the closure-sealing element 112 is positioned along, or proximate the upper edge of the front wall 120, so that the flap 130 will land on the closure-sealing element 112 when the flap 130 is folded over, and onto the front wall 120 to cover the opening 122

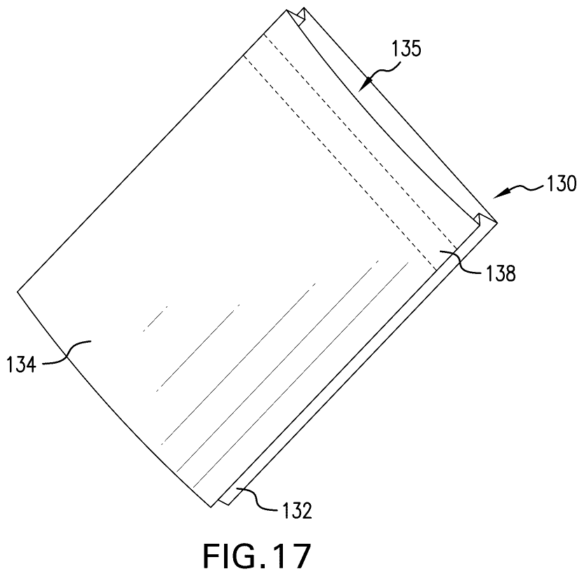

FIG. 17 depicts an envelope 130 comprising gussets 132 positioned between opposing walls 134 of the envelope 130. The walls 134 define an internal containment area or envelope pocket 135 configured to receive an item to be shipped or otherwise held in the envelope 130. The envelope 130, and alternative embodiments thereof, otherwise can be formed with the features of any of the above-described envelopes including, for example, the single or multi-ply walls, inter-ply seals, and inter-wall seals described above. The gussets 132 have a folded configuration that permits the envelope 130 to expand substantially when, for example, an item is inserted into the internal envelope pocket 135 of the envelope 130.

Each gusset 132 can be formed as an integral part of one of the walls 134 of the envelope 130, and can be joined to the other wall 134 by one or more inter-wall seals as disclosed in relation to the above-described embodiments. In other embodiments, the gussets 132 can be formed separately from the walls 134, and can be joined to each of the opposing walls 134 by the inter-wall seals.

A closure-sealing element 138, formed from hot-melt adhesive as discussed above in relation the envelope 10, is disposed on the inwardly-facing surface of one of the walls 134, at or near the upper edge of the wall 134, to form a closure seal that affixes the upper ends of the walls 124 to each other.

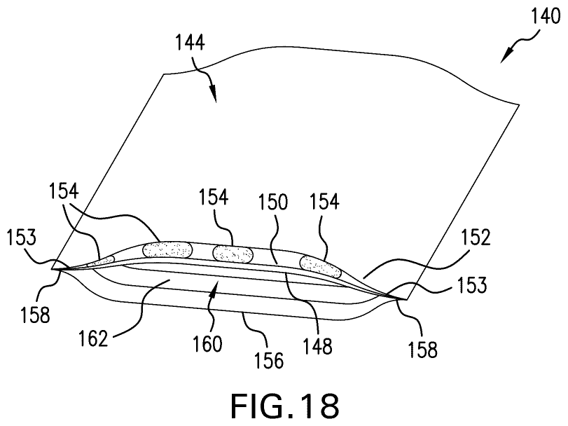

FIG. 18 depicts an envelope 140 that includes a multi-ply wall 144 configured as follows. The envelope 140 otherwise can include the features of one or more of the above-described envelopes. The 144 wall comprises a first ply 148, a second ply 150, and a third ply 152. The region between the first and second plies 148, 150 is substantially empty, with the exception of inter-ply seals 153 that join the first ply 148 to the second ply 150. The second ply thus can slide in relation to the first ply 148.

The region between the second and third plies 150, 152 includes a material 154, such as a cushioning or padding material, a thermally-insulting material, or other types of expandable and non-expandable materials. For example, the material 154 can be a foam padding material.

As another example, the material 154 can be an expansion material adhered to one or both of the second and third plies 150, 152. The expansion material is configured to assume an expanded configuration upon activation by an expansion initiator. The expansion initiator can be, for example, thermal, mechanical, and/or chemical, and/or can include other suitable initiating properties for activating the expansion material. The expansion material, in its expanded state, can provide the envelope 140 with cushioning, thermally-insulative, or other properties.

The second and third plies 150, 152 and the material 154 form another layer that can slide in relation to the first ply 148.

In alternative embodiments, the material 154 can be disposed in the region between the first and second plies 148, 150; and the region between the second and third plies 150, 152 can be substantially empty, with the exception of the inter-ply seals 153. In other alternative embodiments, the material 154 can be disposed in both the region between the first and second plies 148, 150, and the region between the second and third plies 150, 152.

The envelope 140 further includes a single-ply wall 156 that opposes the wall 144, and is joined to the wall 144 by inter-wall seals 158. The walls 144, 156 define an internal containment area or envelope pocket 160 configured to receive an item to be held in the envelope 140. In alternative embodiments, the wall 156 can be a multi-ply wall, and can be configured with the padding, cushioning, or thermally-insulating material 154 in a manner similar to the wall 144.

A closure-sealing element 162, formed form a hot-melt adhesive as discussed above in relation to the envelope 10, is disposed on the inwardly-facing surface of the wall 156, at or near the upper edge of the wall 156. The closure-sealing element 162 can be activated after an item has been inserted into the envelope pocket 135, to form a closure seal that affixes the upper ends of the walls 144, 156 to each other. The closure seal thereby maintains the envelope pocket 160 in a closed state so that the packaged item is retained within the envelope pocket 160. The closure-sealing element 162 can be disposed on the inwardly-facing surface of the wall 148, at or near the upper edge of the wall 144 in alternative embodiments.

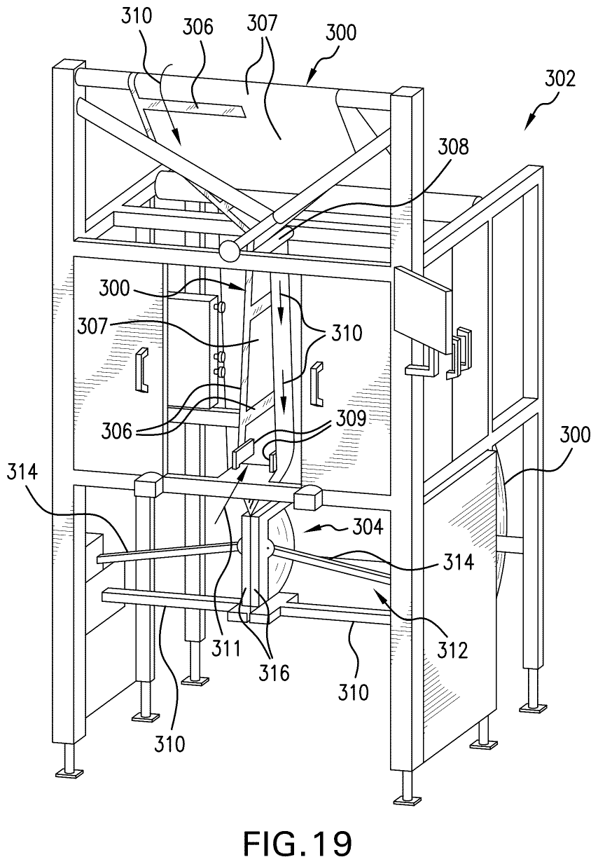

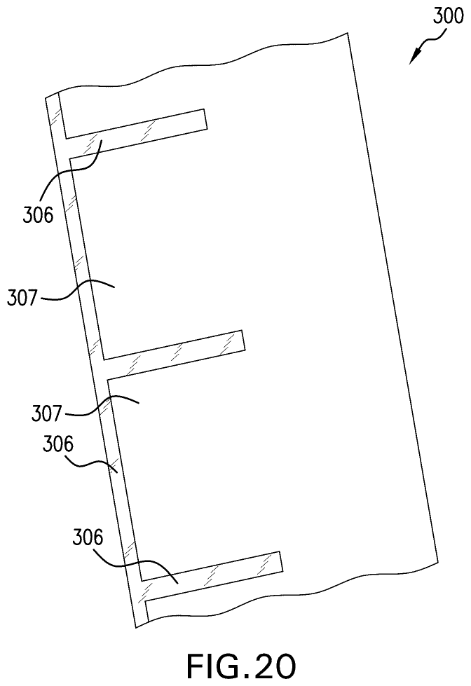

FIG. 19 depicts a bagging machine 302 that forms a web stock 300 into a C-folded configuration, and then seals the folded structure around a product to form a closed envelope. An example of the web stock 300 is depicted by itself in FIG. 20. The web stock 300 comprises a single layer in the form of a ply 307 of paper. The web stock 300 can have a multi-layer configuration in alternative embodiments.

Closure-sealing elements 306, formed from a hot-melt adhesive as discussed above in relation to the envelope 21, are disposed one transverse side of the web stock 300, for example, as depicted in FIG. 20, on an outer surface of the ply 307. The closure-sealing elements 306 are positioned to mate with the opposing transverse side of the web when the web stock 300 is C-folded, so that the closure-sealing elements 306 span all, or alternatively most, of the width of the C-folded envelope to form a seal between the opposite sides of the C-fold. The closure-sealing elements 306 in this embodiment are also disposed in one longitudinally-extending band located one side edge portion of the web stock 300, and in bands that extend transversely across approximately half the width of the web stock 300. In alternative embodiments, the transversely-extending closure-sealing elements 306 can extend across most, or all of the width of the web stock 300. In other alternative embodiments, the outer surface of the ply 307 can be flood coated with the hot-melt adhesive that forms the closure-sealing elements 306.

The web stock 300 can be supplied, for example, as a roll or a fanfolded stack mounted on the supply side of the bagging machine 302, as depicted in FIG. 19. The web stock 300 can be supplied in other configurations in the alternative.

The web stock 300 is drawn through opposing guides 308 of the bagging machine 302 in a manner that causes the web stock 300 to fold along a longitudinally extending fold line, which in turn causes the web stock 300 to assume a C-folded configuration. As can be seen in FIG. 19, when the web stock 300 is folded in this manner, the longitudinally-extending closure-sealing elements 306 on the side edge portion of the web stock 300 align with, and oppose the other side edge portion of the web stock 300, which is devoid of hot-melt adhesive; and the transversely-extending closure-sealing elements 306 likewise oppose portions of the web stock 300 that are devoid of hot-melt adhesive.

As the C-folded folded web stock 300 travels downward, as denoted by the arrows 310, opposing fingers 309 located in a loading area of the bagging machine 302 spread the side edges of web stock 300 apart. This allows an item to be packaged to be inserted into the partially formed envelope 304, as denoted by the arrow 311. As discussed below, the transversely-extending closure-sealing elements 306 at the bottom end of the web stock 300 had been activated during formation of the previous envelope 304, and thus forms a lower transverse seal that prevents the item from falling downward after being loaded into the partially formed envelope 304.

The bagging machine 302 includes a pulling device in the form of two opposing arms 310 that reciprocate between an inward position, shown in FIG. 19, and an outward position (not shown). The arms 310 also translate between a lower position shown in FIG. 19, and an upper position (not shown). The arms 310 can grasp the lower end of the web stock 300, which coincides with the lower end of the partially-formed envelope 304, when the arms 310 are in their inward and upper position. Subsequent downward movement of the arms 310 pulls the bottom end of the web stock 300, and the partially-formed envelope 304 downward to the position shown in FIG. 19. The movement of the bottom edge of the web stock 300 also causes the web stock 300 to advance through the bagging machine 302. The pulling device can have a configuration other than the arms 310 in alternative embodiments.

The bagging machine 302 further includes a cutting and sealing unit in the form of two opposing arms 314 that reciprocate between an inward position, shown in FIG. 19, and an outward position (not shown); and two L-shaped sealer-cutters 316 each mounted on an end of a respective one of the arms 314.

After the pulling device, e.g., the arms 310, has drawn the bottom end of the web stock 300 and the partially-formed envelope 304 downward to the position shown in FIG. 19, the arms 314 move to their inward positions, bringing the sealer-cutters 316 into contact with the partially formed envelope 304.

The L-shaped configuration of the sealer-cutters 316 causes the sealer-cutters 316 to align with the longitudinally-extending closure-sealing elements 306 which, as noted above, align with and oppose the opposite side edge portion of the web stock 300, which is devoid of hot-melt adhesive, due the C-folded configuration of the web stock 300. The L-shaped configuration of the sealer-cutters 316 likewise causes the sealer-cutters 316 to align with the upper, transversely-extending closure-sealing elements 306, which likewise opposes a portion of the web stock 300 that is devoid of hot-melt adhesive. The sealer-cutters 316 heat and press the closure-sealing elements 306, forming a longitudinally-extending seal along one side of the envelope 304, and a transversely-extending seal along the top of the newly-formed envelope 304. As noted above, the transversely-extending seal along the bottom of the envelope 304 already had been formed during manufacture of the previous envelope 304.

In alternative embodiments, the cutting and sealing unit can include, for example, a rolling longitudinal sealer and a horizontal bar in lieu of the arms 314 and the sealer-cutters 316. In alternative embodiments, the cutting and sealing unit 312 can include, for example, a horizontal sealer that rolls or slides across the web stock 300.

Alternative embodiments of the bagging machine 302 can include rollers to help draw the opposing sides of the web stock 300 together, to bring the longitudinally-extending band of hot-melt adhesive 306 on the side edge portion of the web stock 300 into contact with the other side edge portion of the web stock 300.

Once the longitudinal and transverse seals have been formed, the sealer-cutters 316 can sever the newly formed envelope 304 from the web stock 300 by a suitable means such as cutting, focused application of heat along the line of separation, pulling the envelope 304 away from the web stock 300, etc. Because the line of separation runs through the closure-sealing element 306, the portion of this band that remains on the web stock 300 after the cutting process forms the lower transverse seal for the next envelope 304 to be formed from the web stock 300.

The newly-formed and loaded envelope 304, upon being separated from the web stock 300, can drop onto a conveyor (not shown) or other means for transporting or holding the envelope 304.

The above description of the bagging machine 302 is presented for illustrative purposes only. The C-folded envelope 304, and alternative embodiments thereof, can be formed using other type of bag makers.

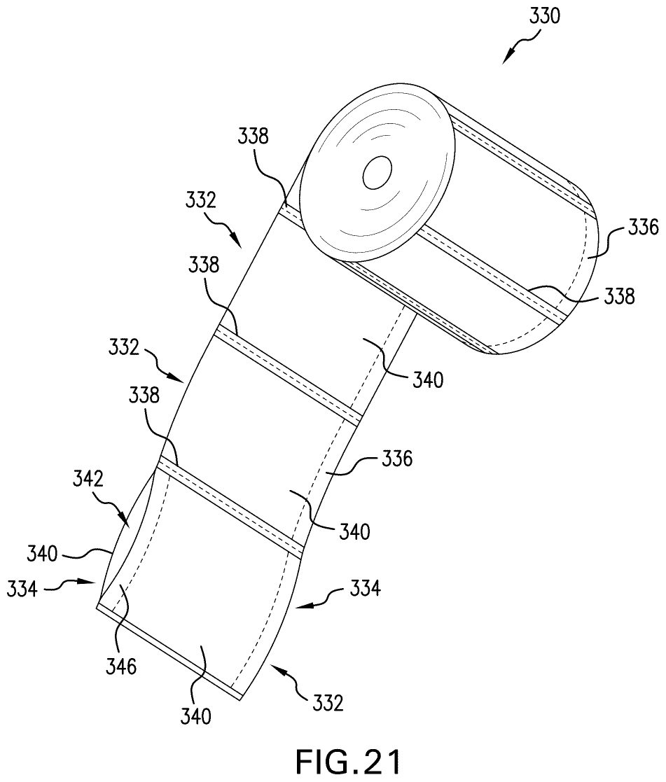

FIG. 21 depicts a web stock 330 of side-loading envelopes 332. The web stock 330 is formed from two webs 334. Each web 334 has a two-layer configuration comprising two plies affixed by inter-ply seals. The webs 334 are joined to form the web sock 330 by one inter-wall seal 336 extending continuously along one side of the web stock 330, and by a plurality of inter-wall seals 338 extending transversely across the web stock 330. Individual envelopes 332 are separated from the web stock 330 through lines of separation that pass through each inter-wall seal 338.

Each individual envelope 332 within the web stock 330 includes two opposing walls 340 that define an envelope pocket 342 of the envelope 332. The end of the envelope pocket 342 on the unsealed side of the web stock 330 is open, so that an item to be packaged can be inserted into the envelope pocket 342 manually, or by an automated machine, as denoted by the arrow 344. Once the item has been inserted, a closure-sealing element 346, in the form of a hot-melt adhesive as discussed above in relation to the envelope 10 and located on the inwardly-facing surface of one of the walls 340, can be activated to form a closure seal that affixes the ends of the walls 340 to each other. The closure seal thereby maintains the envelope pocket 342 in a closed state so that the packaged item is retained within the envelope pocket 342.

The closure-sealing element 346 is depicted as bordering the upper edge of the associated wall 340. In alternative embodiments, the closure-sealing element 346 can be longitudinally offset from the upper edge of the wall 340.

Once the envelope pocket 342 has been closed, the loaded envelope 332 can be severed from the web stock 330 by an appropriate means such as heating, the focused application of heat, pulling, etc.

Alternative embodiments of the envelopes 332 can include a closure flap on the open transverse side of the envelope 332. The closure-sealing element 346 can be disposed on the closure flap, or on the exterior surface of the envelope 332 onto which the closure flap rotates.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. An envelope for holding an item, comprising:
a body that includes:
a first flexible wall, and
a second flexible wall overlying the first flexible wall and affixed to the first flexible wall about at least a portion of a pocket border, which pocket border encloses a pocket defined between the first and second flexile walls and configured and dimensioned to contain the item, at least one of the first and second flexible walls defining a pocket opening allowing access to the pocket from an exterior of the envelope for loading the item into the pocket; and
a closure-sealing element disposed on the body and positioned to seal closed the pocket opening, the closure-sealing element being made of a hot-melt adhesive that:
has a sufficiently low tackiness at room temperature to enable the closure-sealing element to be separated from the second flexible wall by hand, and
is activatable when heated to a temperature above an activation temperature and, when subsequently cooled to a temperature below the activation temperature, adheres to the second flexible wall to seal the pocket opening closed to retain the item in the pocket.

2. The envelope of claim 1, wherein the hot-melt adhesive has a sufficiently low tackiness at room temperature to enable the closure-sealing element to be peeled from the second flexible wall.

3. The envelope of claim 1, wherein the hot-melt adhesive has a sufficiently low tackiness at room temperature to enable the closure-sealing element to be separated from the second flexible wall without damaging the first or the second flexible wall.

4. The envelope of claim 1, wherein the first and second flexible walls are affixed to each other about a first portion of the pocket border, and are unaffixed to each other at the pocket opening.

5. The envelope of claim 4, wherein the first and second flexible walls are unaffixed at an open side of the pocket; and wherein the pocket opening is defined by the open side of the pocket.

6. The envelope of claim 5, wherein the pocket opening is disposed along the pocket border.

7. The envelope of claim 1, wherein the pocket opening is defined between the first and second flexible walls.

8. The envelope of claim 7, wherein the closure-sealing element is configured to seal closed the pocket opening by affixing the second flexible wall to the first flexible wall.

9. The envelope of claim 8, wherein the closure-sealing element is disposed at the pocket opening.

10. The envelope of claim 8, wherein the hot-melt adhesive is offset from an upper edge of the first wall by a sufficient distance to permit the user to manually grasp and pull apart the first and second walls after the closure seal has been formed.

11. The envelope of claim 8, wherein the hot-melt adhesive is configured to be reactivated by the application of heat through at least one of the first and second flexible walls of the envelope, the application of heat being sufficient to heat the hot-melt adhesive to the temperature above the activation temperature.

12. The envelope of claim 1, wherein the closure-sealing element is disposed on the body in an elongated band.

13. The envelope of claim 1, wherein the hot-melt adhesive has a sufficiently low tackiness at temperatures of about 110° F. and below to enable the closure-sealing element to be separated from the second flexible wall by hand.

14. The envelope of claim 1,
wherein the body further comprises a flap connected to the first flexible wall;
wherein the closure-sealing element is disposed on the flap; and
wherein the closure-sealing element is configured to seal closed the pocket opening by affixing the second flexible wall to the flap.

15. The envelope of claim 1, wherein the hot-melt adhesive has an activation temperature below about 140° F.

16. The envelope of claim 1, wherein the closure-sealing element and the pocket border define a gap configured to provide venting between the envelope pocket and the ambient environment.

17. The envelope of claim 1, wherein the at least one of the first and second flexible walls is a padded wall.

18. A supply web, comprising a plurality of the envelopes of claim 1 connected in series.

19. A method of making an envelope for holding an item, comprising:
providing a body of the envelope comprising a first and a second flexible wall;
affixing the second flexible wall to the first flexible wall about at least a portion of a pocket border which pocket border encloses a pocket defined between the first and second flexile walls and configured and dimensioned to contain the item, at least one of the first and second flexible walls defining a pocket opening allowing access to the pocket from an exterior of the envelope for loading the item into the pocket; and
positioning a closure-sealing element on the body to seal closed the pocket opening, the closure-sealing element being made of a hot-melt adhesive that:
has a sufficiently low tackiness at room temperature to enable the closure-sealing element to be separated from the second flexible wall by hand, and
is activatable when heated to a temperature above an activation temperature and, when subsequently cooled to a temperature below the activation temperature, adheres to the second flexible wall to seal the pocket opening closed to retain the item in the pocket.

20. A method for packaging an item, comprising:
providing an envelope comprising:
a body including a first flexible wall, and a second flexible wall overlying the first flexible wall and affixed to the first flexible wall about a containment border that encloses a plurality of sides of a pocket defined by the first and second flexible walls; and
a closure-sealing element disposed on the body and positioned to seal closed the pocket opening, the closure-sealing element being made of a hot-melt adhesive that:
has a sufficiently low tackiness at room temperature to enable the closure-sealing element to be separated from the second flexible wall by hand, and
is activatable when heated to a temperature above an activation temperature and, when subsequently cooled to a temperature below the activation temperature, adheres to the second flexible wall to seal the pocket opening closed to retain the item in the pocket;
placing the item in the pocket; and
heating the closure-sealing element to the temperature above the activation temperature.
